(19) United States
(12) Patent Application Publication
(10) Pub. No.: US 2007/0175479 A1
(43) Pub. Date: Aug. 2, 2007

(54) Apparatus to provide continuous positive airway pressure

(76) Inventor: David Groll, Murrysville, PA (US)

Correspondence Address: JAMES RAY & ASSOCIATES, 2640 PITCAIRN ROAD, MONROEVILLE, PA, 15146, US

(21) Appl. No.: 11/341,694

(22) Filed: Jan. 27, 2006

(51) Int. Cl. A62B 18/08

(52) U.S. Cl. 128/206.24; 128/206.27; 128/207.11

(57) ABSTRACT

Apparatus for communicating a positive fluid pressure to a patient's nasal passageways includes a pair of crush resistant nasal prongs disposed within a respective one of such patient's nasal passageways for delivering at least one of air, oxygen and a combination of air and oxygen to such patient's air passageways. There is a member engageable with at least a portion of said first open end of each one of said pair of crush resistant nasal prongs for substantially sealing them to at least a portion of an inner wall of such air passageways. A crush resistant fluid communication device engages with the second open end of each of the nasal prongs for communicating the at least one of air, oxygen and a combination of air and oxygen to the nasal prongs. Another device is disposed on such apparatus which is engageable with the fluid communication member for retaining the nasal prongs in position in such patient's air passageways during use.

### FIELD OF THE INVENTION

The present invention relates, in general, to equipment used in the treatment of sleep apnea and other respiratory ailments and, more particularly, the instant invention relates to an apparatus to deliver a fluid pressure to a patient in order to at least one of maintain the patient's airway open while sleeping, deliver oxygen to such patient and a combination thereof.

### BACKGROUND OF THE INVENTION

As is well known in the medical field, sleep apnea is a disorder that commonly affects more than 12 million people in the United States alone. It takes its name from the Greek word apnea, which means “without breath.” People with sleep apnea literally stop breathing repeatedly during their sleep, often for a minute, or longer, and as many as hundreds of times during a single night.

Sleep apnea, as is also known, can be caused by either complete obstruction of the airway (obstructive apnea) or partial obstruction (obstructive hypopnea—hypopnea is slow, shallow breathing), both of which can cause the person suffering from such sleep apnea to wake up.

There are three types of sleep apnea—obstructive, central, and mixed. Of these, obstructive sleep apnea (OSA) is the most common. OSA occurs in approximately 2 percent of women and 4 percent of men over the age of 35.

The exact cause of OSA remains unclear. The site of obstruction in most patients is the soft palate, extending to the region at the base of the tongue. There are no rigid structures, such as cartilage or bone, in this area to hold the airway open. During the day, muscles in the region keep the passage wide open. But as a person with OSA falls asleep, these muscles relax to a point where the airway collapses and becomes obstructed.

When the airway closes, breathing stops and the sleeper awakens to open the airway. The arousal from sleep usually lasts only a few seconds, but brief arousals disrupt continuous sleep and prevent the person from reaching the deep stages of slumber, such as rapid eye movement (REM) sleep, which the body needs in order to rest and replenish its strength. Once normal breathing is restored, the person falls asleep only to repeat the cycle throughout the night.

Typically, the frequency of waking episodes is somewhere between 10 and 60. A person with severe OSA may have more than 100 waking episodes in a single night.

Positive airway pressure has been demonstrated to be a very effective treatment for obstructive sleep apnea. It has three forms: continuous positive airway pressure (CPAP), autotitration and bi-level positive airway pressure (BIPAP). In most cases, positive airway pressure is easier to tolerate at lower pressures. Every patient requires a different pressure. To determine precisely the individual patient's optimum airway pressure, it is necessary to titrate the pressure to each individual patient during a polysomnogram. A polysomnogram will show not only when the respiratory events have ceased, but also when the arousals from the respiratory events occur.

CPAP, the more common of the three therapy modes, usually is administered at bedtime through a facial mask held in place by straps around the patient's head. The mask is connected by a tube to a small air compressor about the size of a shoe box. The CPAP machine sends air under pressure through the tube into the mask, where it imparts positive pressure to the upper airways. This essentially “splints” the upper airway open and keeps it from collapsing.

Approximately 55 percent of patients who use CPAP do so on a nightly basis for more than four hours. It is the most commonly prescribed treatment for OSA. The advantages of CPAP are that it is very safe and completely reversible. Generally, it is quite well tolerated. The main disadvantage is that it requires active participation every night; that is, the patient must put it on for it to work.

All types of positive airway pressure use a mask to deliver the pressure to the patient. Regardless of the method of delivering positive pressure, mask fitting is an essential element of a patient's success with positive airway pressure therapy since it affects compliance and effectiveness of treatment. Higher pressures can result in air leak and patient discomfort. Demands on mask stability increase as pressure increases. Higher pressures may also require tighter head gear to maintain an adequate seal contributing to the discomfort. When selecting a CPAP mask the following factors should be considered.

Comfort

Quality of air seal

Convenience

Quietness

Air venting

Certain side effects of CPAP at least include contact dermatitis, skin breakdown, mouth leaks, nasal congestion, runny nose (rhinorrhea), dry eyes, nose bleeds (rare), tympanic membrane rupture (very rare), chest pain, difficulty exhaling, pneumothorax (very rare), smothering sensation, and excessive swallowing of air (aerophagia).

Nasal congestion often can be reduced or eliminated with nasal steroid sprays and humidification placed into the machine. Rhinorrhea can be eliminated with nasal steroid sprays or ipratroprium bromide nasal sprays. Epistaxis is usually due to dry mucosa and can be combated with humidification. Dry eyes are usually caused by mask leaks and can be eliminated by changing to a better fitting mask.

As discussed above and prior to the conception and development of the present invention, in patients having a sleeping disorder, it has been known in the prior art to use masks that have been located on the patient's face and held in place by a harness formed from straps extending from the mask around the wearer's head and/or neck. In the prior art, the mask is formed using a compliant plastic skin-contacting portion that forms an interface to seal with the patient's skin and provide fluid flow to the patient's airways. This compliant plastic “interface” is supported with some kind of rigid or semi rigid structure that can take the form of a faceplate, cushion support or prong support.

Additionally, such a mask includes some type of “exhalation valve” which serves to exhaust excess flow from the CPAP machine to the atmosphere and to exhaust exhaled CO2 from the fluid path to prevent the exhaled CO2 from being rebreathed by the patient.

Normally attached to such mask is a generally hollow tube which is usually independent of the harness. Such hollow tube directs a breathable gas, such as air and/or oxygen, to the wearer.

This arrangement has several disadvantages. First, the cushions are difficult to fit to the patient as each patient has a different facial structure. Poor mask fir leads to air leaks, which diminishes therapy and can cause adverse side effects like dry eyes.

Second, the plastic interface portion is liquid and gas impermeable. This arrangement blocks off the pores of the skin on the portion of the mask which is in contact with the patient. This leads to skin oils collecting between the skin and the interface causing the patient to feel constricted.

Third, the use of a rigid or semi rigid support structure around the face is uncomfortable for the patient. The rigid portions of the mask can press against the patient's face during sleep causing discomfort. Anytime the patient moves, the mask tends to become dislodged.

Fourth, the exhalation valve arrangements normally involve some type of hole or slit in the rigid support structure. This hole results in a jet of air being exhausted from the mask that can cause noise, disturbing the sleep of the patient or their bed partner. Also, this jet of air can blow on the bed partner, further disturbing their sleep.

Additionally, the hollow tube can oftentimes be inadvertently pulled by movement of the wearer, particularly during sleep, which may dislodge the mask and adversely affect gas delivery to the patient's airways, thereby significantly reducing the effectiveness of the treatment.

Another important disadvantage is that the mask, straps and hollow tube are prone to entanglement which increases the difficulty of correctly installing the mask and harness.

Finally, a further disadvantage is that the patient often must use a chinstrap to keep the mouth closed during use. This prevents leaking of the positive airway pressure from the mouth but makes the use of CPAP therapy more cumbersome for the patient.

The present invention seeks to overcome or at least ameliorate these problems associated with the prior art type devices.

### SUMMARY OF THE INVENTION

In a presently preferred embodiment, the present invention provides an apparatus for communicating a fluid pressure to a patient's nasal passageways or air passageways disposed in fluid communication with a patient's mouth to at least one of alleviate sleep apnea symptoms and provide oxygen to patients suffering from an affliction requiring such oxygen. This apparatus includes a first means having each of a first open end and a second open end. The first open end of such first means being disposed for communicating at least one of air, oxygen and a combination of air and oxygen to such patient's nasal passageways or air passageways disposed in fluid communication with such patient's mouth. Air being supplied for example with patients suffering from sleep apnea and oxygen to patients suffering from various lung ailments. A second means is engageable with at least a portion of such first means for substantially sealing the first means to at least a portion of at least one of an inner wall of a respective one of such patient's pair of nasal passageways and an area adjacent such patient's air passageways disposed in fluid communication with a patient's mouth. There is a fluid communication means engageable with the second open end of such first means for communicating the at least one of such air, oxygen and a combination of air and oxygen to the second open end of such first means. Further, there is a means disposed on the apparatus which is engageable with such fluid communication means for retaining the first open end of such first means in at least a portion of at least one of an inner wall of a respective one of such patient's pair of nasal passageways and an area adjacent such patient's air passageways disposed in fluid communication with a patient's mouth during use. The final essential element of the apparatus of the present invention is an exhalation valve disposed on the apparatus adjacent such sealing means for exhausting CO2 being exhaled from such patient to atmosphere.

### OBJECTS OF THE INVENTION

It is, therefore, one of the primary objects of the present invention to provide an apparatus for communicating a positive fluid pressure to a patient's nasal and/or air passageways which is less likely to become dislodged during use.

Another object of the present invention is to provide an apparatus for communicating a positive fluid pressure to a patient's nasal and/or air passageways which is less likely to become tangled during use.

Still another object of the present invention is to provide an apparatus for communicating a positive fluid pressure to a patient's nasal and/or air passageways which is more comfortable for the patient.

Yet another object of the present invention is to provide an apparatus for communicating a positive fluid pressure to a patient's nasal and/or air passageways having substantially improved air sealing capability.

A further object of the present invention is to provide an apparatus for communicating a positive fluid pressure to a patient's nasal and/or air passageways which is generally more convenient than prior art type mask.

An additional object of the present invention is to provide an apparatus for communicating a positive fluid pressure to a patient's nasal and/or air passageways which is relatively quiet during operation.

Still yet another object of the present invention is to provide an apparatus for communicating a positive fluid pressure to a patient's nasal and/or air passageways having improved air venting capability.

Yet still another object of the present invention is to provide an apparatus for communicating a positive fluid pressure to a patient's nasal and/or air passageways substantially all portions of such apparatus which touches a patient's face is made of cloth which acts as an exhalation valve.

A still further object of the present invention is to provide an apparatus for communicating a positive fluid pressure to a patient's nasal and/or air passageways wherein said apparatus is substantially capable of conforming to a patient's facial features.

Another object of the present invention is to provide an apparatus for communicating a positive fluid pressure to a patient's nasal and/or air passageways in which there are substantially no moisture-impermeable surfaces in contact with a patient's skin.

Yet another object of the present invention is to provide an apparatus for communicating a positive fluid pressure to a patient's nasal and/or air passageways in which there are no rigid parts to press against the skin while the patient sleeps.

In addition to the various objects and advantages of the present invention which have been described above, various other objects and advantages of the invention will become more readily apparent to those persons skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a plan view of a presently preferred embodiment of the invention;

FIG. 2 is a plan view of the apparatus illustrated in FIG. 1 showing a presently preferred adjustment means for retaining the apparatus in position on the patient's head;

FIG. 3 is a plan view of an alternative embodiment of the present invention;

FIG. 4 is a plan view of yet another alternative embodiment of the present invention;

FIG. 5 is a perspective view of a mask type apparatus according to another alternative embodiment of the invention; and

FIG. 6 is a front view of the mask type apparatus illustrated in FIG. 5.

FIG. 7 is a side elevation view of a mask type apparatus according to another alternative embodiment of the invention; and

FIG. 8 is a front view of the mask type apparatus illustrated in FIG. 7.

### BRIEF DESCRIPTION OF A PRESENTLY PREFERRED AND VARIOUS ALTERNATIVE EMBODIMENTS OF THE PRESENT INVENTION

Prior to proceeding to the more detailed description of the instant invention it should be noted that identical components having identical functions have been designated with identical reference numerals throughout the several views illustrated in the drawings for the sake of clarity.

As used in the present specification and claims the term cloth is meant to include natural and synthetic fiber cloth, treated cloth, laminates having a cloth base and cloth which is permeable and impermeable to air.

Now refer more particularly to FIGS. 1-4. Illustrated therein is are the presently preferred embodiments of an apparatus, generally designated 10, for communicating a positive fluid pressure to a patient's nasal passageways (not shown) to at least one of alleviate sleep apnea symptoms and provide oxygen to patients suffering from an affliction requiring such oxygen.

The apparatus 10 includes a pair of nasal prongs 12 and 14 having each of a first open end and a second open end. Such first open end of one of such pair of nasal prongs 12 and 14 being disposed within a respective one of a pair of such patient's nasal passageways for delivering at least one of air, oxygen and a combination of air and oxygen to such patient's air passageways.

In the presently preferred embodiment of the invention, such pair of nasal prongs 12 and 14 are formed from a preselected material selected from the group consisting of cloth, relatively soft plastic, rubber, treated paper and various combinations thereof. At the present time the most preferred material for use in the pair of nasal prongs 12 and 14 is cloth. Additionally, it can be noted here that it is presently preferred for substantially the entire apparatus 10 be made from cloth or other soft textile material thereby making it compliant. In this manner the cloth material acts as a means for disposing of excess air flow and exhaled gases within the apparatus 10. Such gases being exhausted through the cloth rather than through a hole or series of holes or mesh.

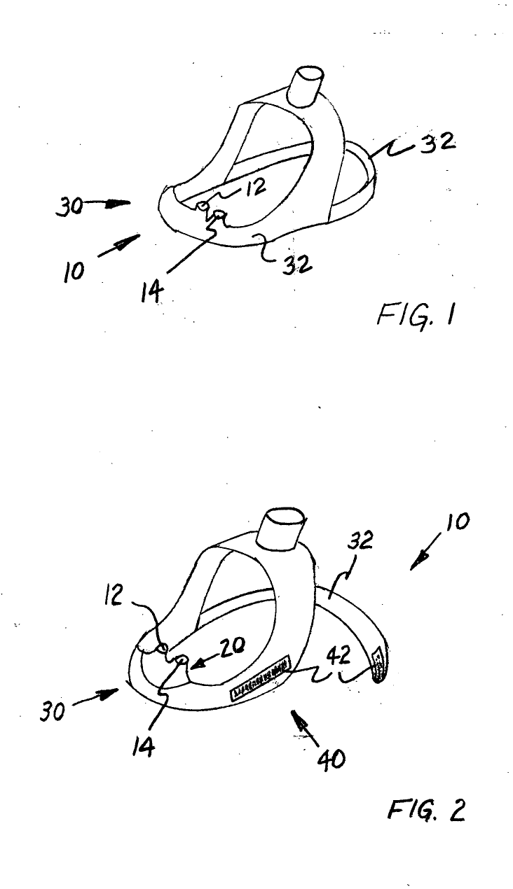

As best seen in FIG. 2, there is a means, generally designated 20, engageable with at least a portion of the first open end of each one of such pair of nasal prongs 12 and 14 for substantially sealing them to at least a portion of an inner wall (not shown) of such respective one of such patient's pair of nasal passageways.

Likewise, in a presently preferred embodiment, the means 20 engageable with such at least a portion of the first open end of each one of such pair of nasal prongs 12 and 14 for sealing them to at least a portion of an inner wall of such respective one of such patient's pair of air passageways is selected from the group consisting of cloth, plastic film silicon gel, vinyl and various combinations thereof. The most preferred material for producing such means 20 is cloth.

A fluid communication means, generally designated 30, is engageable the said second open end of each of such pair of nasal prongs 12 and 14 for communicating the at least one of such air, oxygen and a combination of air and oxygen to such nasal prongs 12 and 14.

As with such pair of nasal prongs 12 and 14 and the fluid communication means 20, in the presently preferred embodiment of the invention, the fluid communication means 20 engageable with such second open end of each of the pair of nasal prongs 12 and 14 is tubing 32. Such tubing 32 is preferably formed from cloth.

The final essential element of the apparatus 10, of the present invention is a means, generally designated 40, disposed on such apparatus 10 and engageable with the fluid communication means 30 for retaining the nasal prongs 12 and 14 in position in such patient's air passageways during use.

In the presently preferred embodiment such means 30 disposed on the apparatus 10 in engagement with the fluid communication means 30 during use is at least one strap 32. Preferably such at least one strap 32 is formed integrally with apparatus 10 as a single piece elastic unit formed from cloth.

Alternatively, such at least one strap 32 includes an adjustment means, generally designated 40 for fitting a different size head of various patients.

Such adjustment means 40 can be selected from the group consisting of a hook and loop type fastener and a tie type fastener. According to the presently preferred embodiment of the invention the adjustment means will be a hook and loop type fastener 42.

In the present invention the fluid communication means 30 further includes a pump means (not shown) for communicating such positive fluid pressure to such patient's nasal passageways.

In the presently preferred embodiment of the invention when it is being used for sleep apnea the pump means will be used and when oxygen is called for a tank means, such as an oxygen tank, having a connection to the fluid communication means 30 will be preferred.

As best seen in FIGS. 1 and 2, such positive fluid pressure can be communicated from such one of a pump means and a tank means to the fluid communication means 30 adjacent a top portion of such patient's head.

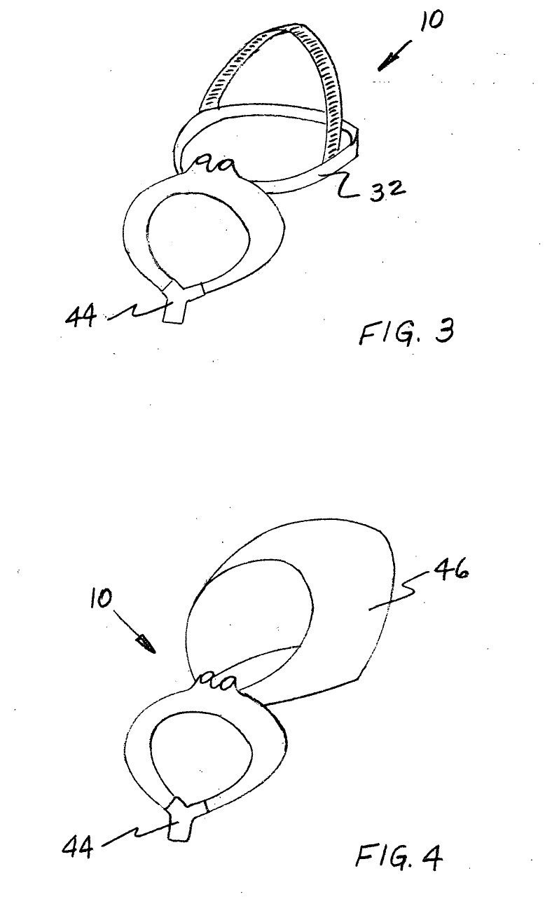

Referring to FIGS. 3 and 4, it can be seen that such positive fluid pressure can also be communicated from such one of a pump means and a tank means to such fluid communication means 30 adjacent a chest of such patient and such apparatus 10 will further include a Y type connector 44 between such one of a pump means and a tank means to such fluid communication means 30 adjacent such chest of such patient.

As an alternative to the strap like member 32 such means 30 disposed on apparatus 10 and engageable with the fluid communication means 30 for retaining the nasal prongs 12 and 14 in position in such patient's air passageways during use is a cap like member 46. Such cap like member 46 is formed from one of a mesh type material and an elastomeric type material with the mesh type material being presently preferred.

The elastomeric type material is, preferably, selected from an elastic cloth type material and a rubber type material.

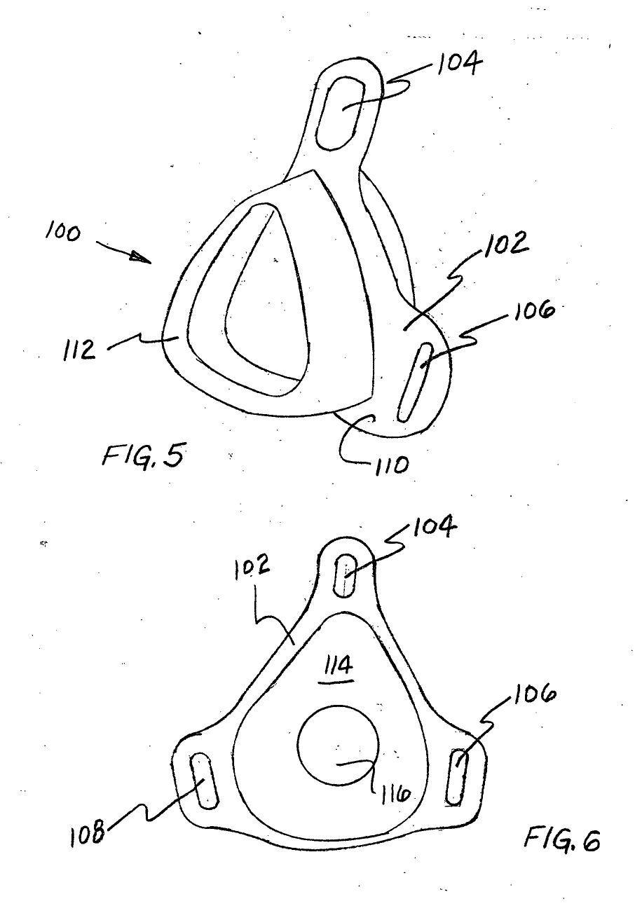

Now refer, more particularly, to FIGS. 5 and 6. Illustrated therein is an another alternative embodiment of the present invention which is a mask type apparatus, generally designated 100. Such mask type apparatus 100 for communicating fluid to a patient preferably includes a faceplate 102 having apertures 104, 106 and 108 formed therein. Apertures 106 and 108 enable a strap like member (not shown) to be engaged therein to hold the mask in place on the patient's face. Disposed on the back side 110 of the mask 100 is a cloth type cushion 112 to both seal the mask to such patient's face and to serve as an exhalation valve. Disposed on the front surface 114 of the faceplate 102 is an air inlet 116 which is connected to tubing (not shown) for communicating a preselected fluid pressure to the apparatus 100.

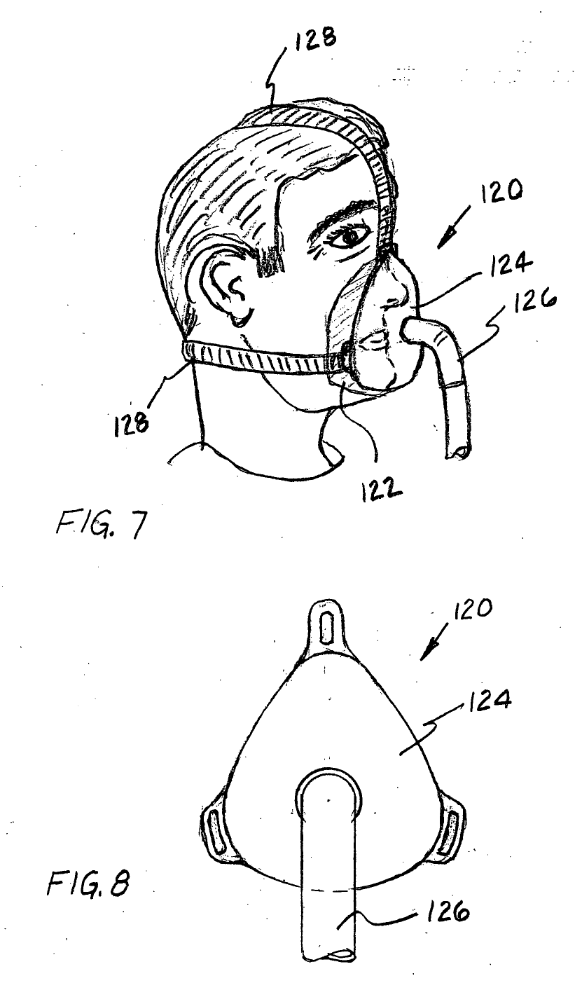

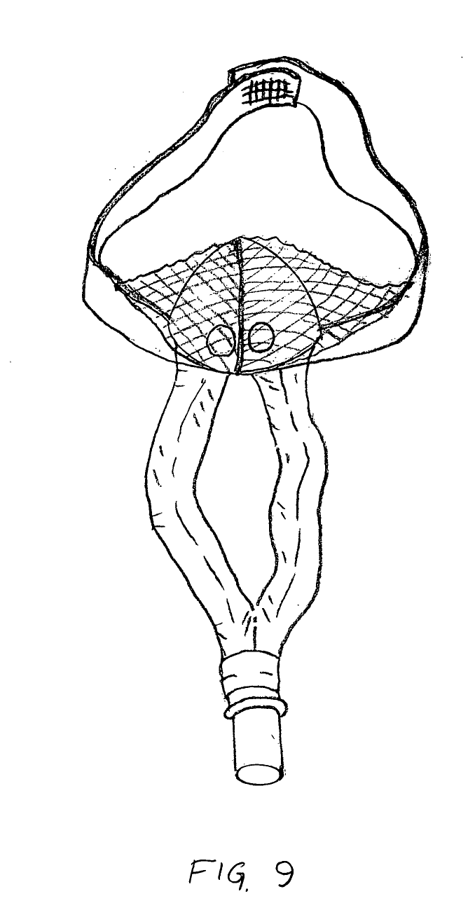

Now refer, more particularly, to FIGS. 7 and 8 wherein yet another embodiment of a mask, generally designated 120, according the present invention is illustrated. In this embodiment there is a cloth cushion 122 disposed around the patient's nasal passageways and mouth and in sealing contact with the face. On the outer portion of the cloth cushion 122 is a face plate 124 having an air tube 126 connected thereto for communicating air pressure to the patient. As can be seen such mask can be held in place by straps 128.

While in accordance with the patent statutes the presently preferred and various alternative embodiments of the instant invention have been described in detail above, it should be understood that various other modifications and alternatives can be envisioned by those persons skilled in the art without departing from either the spirit of the invention or the scope of the appended claims.

1. An apparatus for communicating a positive air pressure to a patient's air passageways to alleviate sleep apnea symptoms, said apparatus comprising:
(a) a cloth mask having each of a first open end and a second open end, said first open end of said cloth mask being disposed for communicating said positive air pressure to such patient's air passageways;
(b) a cloth sealing means engageable with at least a portion of said cloth mask for substantially sealing said cloth mask to at least a portion of an area adjacent such patient's pair of nasal passageways;
(c) a cloth positive air pressure communication means engageable with said second open end of said cloth mask for communicating said positive air pressure to said second open end of said cloth mask;
(d) means disposed on said apparatus and engageable with said cloth positive air pressure communication means for retaining said first open end of said cloth mask in said area adjacent such patient's pair of nasal passageways during use; and
(e) a cloth exhalation valve disposed on said apparatus adjacent said sealing means for exhausting CO2 being exhaled from such patient to atmosphere.

2. An apparatus, according to claim 1, wherein such patient suffers from sleep apnea and said apparatus communicates a positive fluid pressure to such patient's air passageways.

3. An apparatus, according to claim 1, wherein said first means is a pair of nasal prongs formed from a preselected material selected from the group consisting of a cloth, a combination of cloth and relatively soft plastic film, treated paper and various combinations thereof.

4. An apparatus, according to claim 3, wherein said pair of nasal prongs are formed from said cloth.

5. An apparatus, according to claim 1, wherein said second means engageable with said at least a portion of said first means for sealing said first means to said at least one of said at least a portion of an inner wall of a respective one of such patient's pair of nasal passageways and an area adjacent such patient's air passageways disposed in fluid communication with such patient's mouth is selected from the group consisting of cloth, plastic film, silicon gel, vinyl and various combinations thereof.

6. An apparatus, according to claim 5, wherein said first means is a pair of nasal prongs and said second means for sealing said first means to at least a portion of an inner wall of such respective one of such patient's pair of nasal passageways is cloth.

7. An apparatus, according to claim 5, wherein said first means is a mask and said second means for sealing said first means to said area adjacent such patient's pair of nasal passageways is cloth.

8. An apparatus, according to claim 1, wherein said positive air pressure communication means engageable with said second open end of said cloth mask is cloth tubing.

9. An apparatus, according to claim 8, wherein said tubing is formed from cloth.

10. An apparatus, according to claim 1, wherein said means disposed on said apparatus and engageable with said fluid communication means for retaining said first means in position in during use is at least one strap.

11. An apparatus, according to claim 10, wherein said at least one strap is formed integrally with said apparatus as a single piece elastic unit formed from cloth.

12. An apparatus, according to claim 10, wherein said at least one strap includes an adjustment means for fitting different size heads of various patients.

13. An apparatus, according to claim 10, wherein said adjustment means is selected from the group consisting of a hook and loop type fastener and a tie type fastener.

14. An apparatus, according to claim 1, wherein said each of said first means and said second means are formed from cloth and said cloth serves as said exhalation valve.

15. An apparatus, according to claim 2, wherein said positive fluid pressure is communicated to said fluid communication means adjacent a top portion of such patient's head.

16. An apparatus, according to claim 2, wherein said positive fluid pressure is communicated to said fluid communication means adjacent a chest of such patient and said apparatus further includes a Y type connector between a source of such fluid pressure and said fluid communication means adjacent such chest of such patient.

17. An apparatus, according to claim 1, wherein said means disposed on said apparatus and engageable with said fluid communication means for retaining said first means in position in said at least a portion of at least one of an inner wall of a respective one of such patient's pair of nasal passageways and an area adjacent such patient's air passageways disposed in fluid communication with such patient's mouth during use is a cap like member.

18. An apparatus, according to claim 17, wherein said cap like member is formed from one of a mesh type material and an elastomeric type material.

19. An apparatus, according to claim 18, wherein said cap like member is formed from a mesh type material.

20. An apparatus, according to claim 18, wherein said cap like member is formed from an elastomeric type material selected from elastic cloth type material and rubber type material.

21. An apparatus, according to claim 18, wherein said cap like member is formed from an elastomeric type material selected from elastic cloth type material.

22. An apparatus, according to claim 5, wherein said first means is a mask and said second means for sealing said first means to said area adjacent such patient's pair of nasal passageways and mouth, is cloth.
